(19) United States
(12) Patent Application Publication
(10) Pub. No.: US 2007/0273760 A1
(43) Pub. Date: Nov. 29, 2007

(54) Inspection Apparatus and Method

(75) Inventors: Steven Morrison, Elvingston (GB); Stuart James Clarke, Elvingston (GB); Laurance Michael Linnett, Elvingston (GB)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: FORTKEY LIMITED, Elvingston (GB)

(21) Appl. No.: 10/580,876

(22) PCT Filed: Nov. 25, 2004
(86) PCT No.: PCT/GB04/04981

§ 371 Date: Mar. 19, 2007

(30) Foreign Application Priority Data
Nov. 25, 2003 (GB) 0327339.8

(51) Int. Cl. H04N 7/18

(52) U.S. Cl. 348/51; 348/E07.085

(57) ABSTRACT

Apparatus and method for the inspection of an object. A linear array of cameras are located in a stationery position with the object moved over them. An image processor first applies calibration and perspective alterations to the consecutive frames of the cameras, then mosaics the frames together to form a single mosaiced image of the object. An undervehicle car inspection system is described which provides a single image of the entire underside of the vehicle, to scale.

The present invention relates to the inspection of objects including vehicles and in particular to the provision of accurate visual information from the underside of a vehicle or other object.

Visual under vehicle inspection is of vital importance in the security sector where it is required to determine the presence of foreign objects on the underside of vehicles. Several systems currently exist which provide the means to perform such inspections.

The simplest of these systems involves the use of a mirror placed on the end of a rod. In this case, the vehicle must be stationary as the inspector runs the mirror along the length of the car performing a manual inspection. Several problems exist with this set-up. Firstly, the vehicle must remain stationary for the duration of the inspection. The length of time taken to process a single vehicle in this way can lead to selected vehicles being inspected, as opposed to all vehicles.

Furthermore, it is difficult to obtain a view of the entire vehicle underside including the central section. Vitally, this could lead to an incomplete inspection and increased security risk.

In order to combat these problems several camera based systems currently exist which either simply display the video live, or capture the vehicle underside onto recordable media for subsequent inspection. One such system involves the digging of a trench into the road. A single camera and mirror system is positioned in the trench, in such a way as to provide a complete view of the vehicle underside as it drives over. The trench is required to allow the camera and mirror system to be far enough away from the underside of the vehicle to capture the entire underside in a single image. This allows a far easier and more reliable inspection than the mirror on the rod. The main problems with this system lie with the requirement for a trench to be excavated in the road surface. This makes it expensive to install, and means that it is fixed to a specific location.

More portable systems exist which utilize multiple cameras built into a housing similar in shape to a speed bump. These have the advantage in that they may be placed anywhere with no restructuring of the road surface required. However, these systems currently display the video footage from the multiple cameras on separate displays, one for each camera. An operator therefore has to study all the video feeds simultaneously as the car drives over the cameras. The task of locating foreign objects using this type of system is made difficult by the fact that the car is passing close to the cameras. This causes the images to change rapidly on each of the camera displays, making it more likely that any foreign object would be missed by the operator.

It is an object of the present invention to provide a system which provides an image of the entire underside of the vehicle, whilst at the same time being portable and requiring no structural alterations to the road in order to operate.

In accordance with a first aspect of the present invention there is provided an apparatus for inspecting the under side of a vehicle, the apparatus comprising:
a plurality of cameras located at predetermined positions and angles relative to one another, the cameras pointing in the general direction of the area of an object to be inspected; and
image processing means provided with
   (i) a first module for calibrating the cameras and for altering the perspective of image frames from said cameras and
   (ii) a second module for constructing an accurate mosaic from said altered image frames.

Preferably, the plurality of cameras are arranged in an array. More preferably, the array is a linear array.

In use the apparatus of the present invention may be placed at a predetermined location facing the underside of the object to be inspected, typically a vehicle with the vehicle moving across the position of the stationary apparatus.

Preferably the cameras have overlapping fields of view.

Preferably, the first module is provided with camera positioning means which calculate the predetermined position of each of said cameras as a function of the camera field of view, the angle of the camera to the vertical and the vertical distance between the camera and the position of the vehicle underside or object to be inspected.

Preferably, camera perspective altering means are provided which apply an alteration to the image frame calculated using the angle information from each camera.

Preferably, the images from each of said cameras are altered to the same scale.

More preferably, the camera perspective altering means models a shift in the angle and position of each camera relative to the others and determines an altered view from the camera.

The perspective shift can be used to make images from each camera appear to be taken from an angle normal to the object to be inspected or vehicle underside.

Preferably, the camera calibration means is adapted to correct spherical lens distortion and/or non-equal scaling of pixels and/or the skew of two image axes from the perpendicular.

Preferably, the second module is provided with means for comparing images in sequence which allows the images to be overlapped. More preferably, a Fourier analysis of the images is conducted in order to obtain the translation of x and y pixels relating the images.

In accordance with a second aspect of the present invention there is provided a method of inspecting an area of an object, the method comprising the steps of:
(a) positioning at least one camera, taking n image frames, proximate to the object
(b) acquiring a first frame from the at least one camera
(c) acquiring the next frame from said at least one camera
(d) applying calibration and perspective alterations to said frames
(e) calculating and storing mosaic parameters for said frames
(f) repeat steps c to e n−1 times
(g) mosaicing together the n frames from said at least one camera into a single mosaiced image.

Preferably, the object is the underside of a vehicle.

Preferably, a plurality of cameras is provided, each located at predetermined positions and angles relative to one another, the cameras pointing in the general direction of the object.

Preferably, the predetermined position of each of said cameras is calculated as a function of the camera field of view and/or the angle of the camera to the vertical and/or the vertical distance between the camera and the position of the vehicle underside.

Preferably, images from each of said cameras are altered to the same scale.

Preferably, perspective alteration applies a correction to the image frame calculated using relative position and angle information from each camera.

More preferably, perspective alteration models a shift in the angle and position of each camera relative to the others and determines the view therefrom.

The perspective shift can be used to make images from each camera appear to be taken from an angle normal to the object.

Preferably, calibration of the at least one camera corrects spherical lens distortion and/or non-equal scaling of pixels and/or the skew of two image axes from the perpendicular.

Preferably, mosaicing the images comprises comparing images in sequence, applying fourier analysis to the said images in order to obtain the translation in x and y pixels relating the images.

Preferably, the translation is determined by
(a) Fourier transforming the original images
(b) Computing the magnitude and phase of each of the images
(c) Subtracting the phases of each image
(d) Averaging the magnitudes of the images
(e) Inverse Fourier transforming the result to produce a correlation image.

Preferably the positioning of the at least one camera proximate to the vehicle underside is less than the vehicle's road clearance.

Advantageously, the present invention can produce a still image rather than the video. Therefore, each point on the vehicle underside is seen in context with the rest of the vehicle. Also, any points of interest are easily examinable without recourse to the original video sequence.

In accordance with a third aspect of the present invention there is provided a method of creating a reference map of an object, the method comprising the steps of obtaining a single mosaiced image, selecting an area of the single mosaiced image and recreating or selecting the frame from which said area of the mosaiced image was created.

Preferably, the area of the single mosaiced image is selected graphically by using a cursor on a computer screen.

The present invention will now be described by way of example only with reference to the accompanying drawings of which:

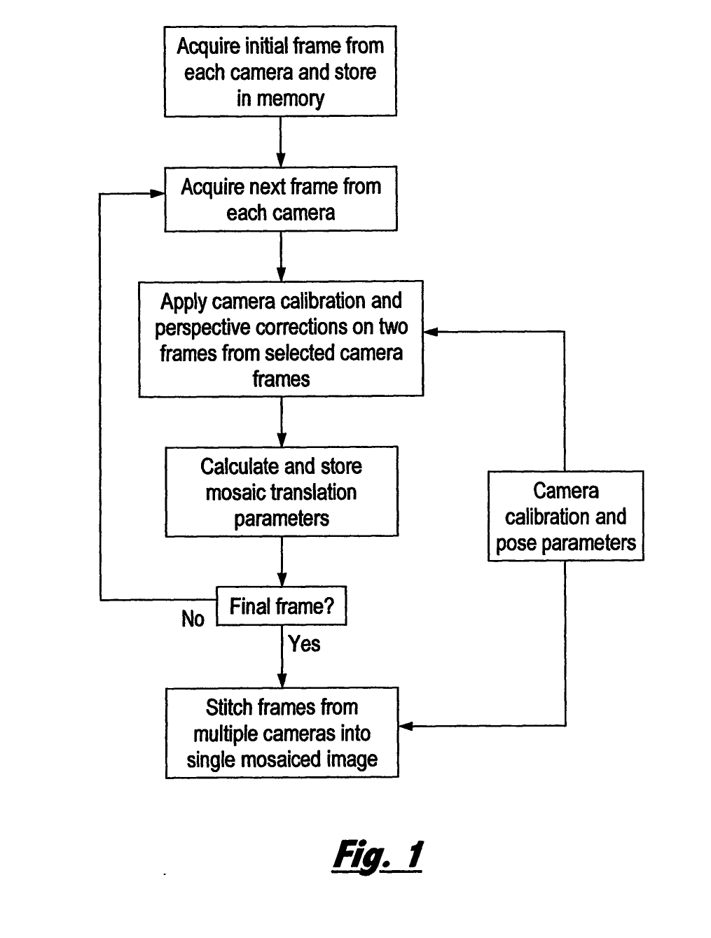

FIG. 1 is a schematic diagram for the high level processes of this invention;

FIG. 2 shows the camera layouts for one half of the symmetrical unit in the preferred embodiment;

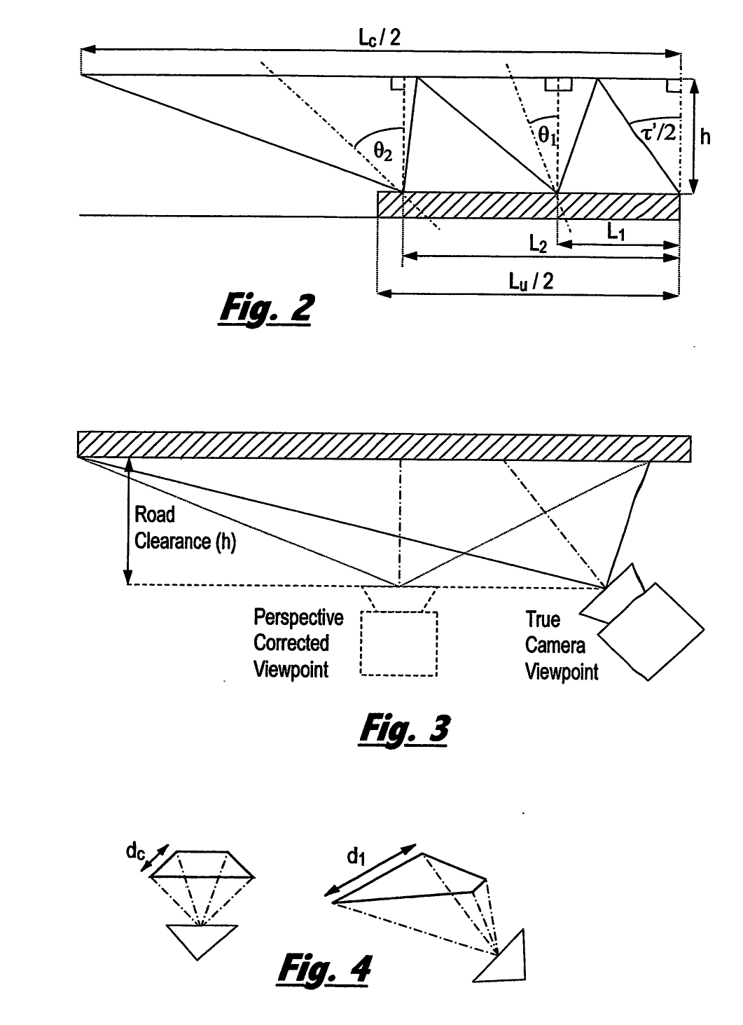

FIG. 3 is schematic of the camera pose alteration required to correct for perspective in each of the image frames by;

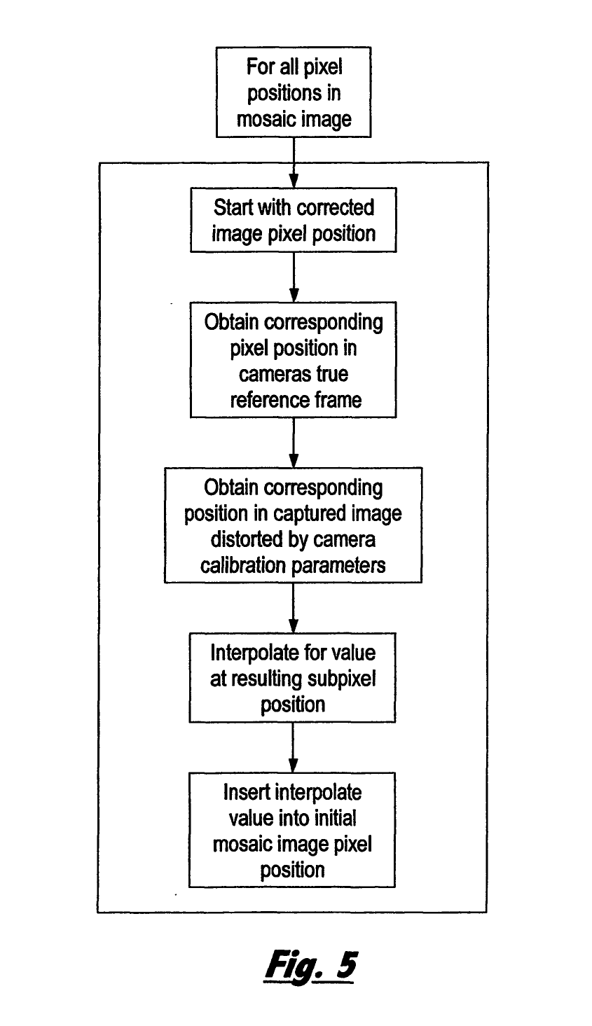

FIG. 4 demonstrates the increase in viewable achieved when the camera is angled; and

FIG. 5 is a flow diagram of the method applied when correcting images for the sensor roll and pitch data concurrently with the camera calibration correction.

A mosaic is a composite image produced by stitching together frames such that similar regions overlap. The output gives a representation of the scene as a whole, rather that a sequential view of parts of that scene, as in the case of a video survey of a scene. In this case, it is required to produce a view of acceptable resolution at all points of the entire underside of a vehicle in a single pass. In this example of the present invention, this is accomplished by using a plurality of cameras arranged in such a way as to achieve full coverage when the distance between the cameras and vehicle is less than the vehicles road clearance.

An example of such a set up using five cameras is provided in FIG. 2; the width of the system being limited by the wheel base of the vehicle. This diagram shows one half of the symmetric camera setup with the centre camera, angled 0° to the vertical, to the right of the figure.

The notation used in FIG. 1 is defined as follows:
L=Width of unit.
L_{c}=Maximum expected width of vehicle.
h=Minimum expected height from the camera lenses to the vehicle.
τ=True field of view of camera.

τ′=Assumed field of view of camera, where τ′=τ−δτ and 0<δ<τ.
θᵢ=Angles of outer cameras to the vertical, where i=1,2.
Lᵢ=Distances of outer cameras from the central camera, where L₁<L₂<Lᵤ/2.

In this notation an assumed field of view τ′ is used, as opposed to the true field of view τ, the reason for this is twofold. Firstly, it provides a redundancy in the cross-camera overlap regions ensuring the vehicle underside is captured in its entirety. Secondly, in the case of a vehicle that is of maximal width, the use of τ in the positioning calculations will lead to resolution problems at the outer edge of the vehicle. These problems become evident when the necessary image corrections are performed.

Knowing L_{c}, h, τ′, and L₂, then θ₂ may be calculated as

$${θ}_{2} = {tan}^{- 1} [ \frac{{L}_{c} - 2 {L}_{2}}{2 h} ] - \frac{{τ}^{′}}{2}$$

Using this geometry θ₁ cannot be determined analytically. It is therefore calculated as the root of the following equation through use of a root finding technique such as the bisection method

$$tan ( \frac{{τ}^{′}}{2} + {θ}_{1} ) + tan ( \frac{{τ}^{′}}{2} - {θ}_{1} ) + [ tan ( \frac{{τ}^{′}}{2} ) + tan ( \frac{{τ}^{′}}{2} - {θ}_{2} ) - \frac{{L}_{2}}{h} ] = 0$$

Following this the distance L₁ is calculated as

$${L}_{1} = h [ tan ( \frac{{τ}^{′}}{2} ) + tan ( \frac{{τ}^{′}}{2} - {θ}_{1} ) ]$$

The use of these equations ensures the total coverage of the underside of a vehicle whose dimensions are within the given specifications.

In estimating the interframe mosaicing parameters of video sequences there are currently two types of method available. The first uses feature matching within the image to locate objects and then to align the two frames based on the positions of common objects. The second method is frequency based, and uses the properties of the Fourier transform.

Given the volume of data involved (a typical capture rate being 30 frames per second) it is important that a technique which will provide us with a fast data throughput is utilized, whilst also being highly accurate in a multitude of working environments. In order to achieve these goals, the correlation technique based on the frequency content of the images being compared is used. This approach has two main advantages:
1. Firstly, regions that would appear relatively featureless, that is those not containing strong corners, linear features, and such like, still contain a wealth of frequency information representative of the scene. This is extremely important when mosaicing regions of the seabed for example, as definite features (such as corners or edges) may be sparsely distributed; if indeed they exist at all.
2. Secondly, the fact that this technique is based on the Fourier transform means that it opens itself immediately to fast implementation through highly optimized software and hardware solutions.

Implementation steps in order of their application will now be discussed.

All cameras suffer from various forms of distortion. This distortion arises from certain artifacts inherent to the internal camera geometric and optical characteristics (otherwise known as the intrinsic parameters). These artifacts include spherical lens distortion about the principal point of the system, non-equal scaling of pixels in the x and y-axis, and a skew of the two image axes from the perpendicular. For high accuracy mosaicing the parameters leading to these distortions must be estimated and compensated for. In order to correctly estimate these parameters images taken from multiple viewpoints of a regular grid, or chessboard type pattern are used. The corner positions are located in each image using a corner detection algorithm. The resulting points are then used as input to a camera calibration algorithm well documented in the literature.

The estimated intrinsic parameter matrix A is of the form

$$A = [ \begin{matrix}α & γ & {u}_{0} \\ 0 & β & {v}_{0} \\ 0 & 0 & 1\end{matrix} ]$$

where α and β are the focal lengths in x and y pixels respectively, γ is a factor accounting for skew due to non-rectangular pixels, and (u₀,v₀) is the principle point (that is the perpendicular projection of the camera focal point onto the image plane).

A prerequisite for using the Fourier correlation technique is that consecutive images must match under a strictly linear transformation; translation in x and y, rotation, and scaling. Therefore the assumption is made that the camera is travelling in a direction normal to that in which it is viewing. In the case of producing an image of the underside of a vehicle, this assumption means that the camera is pointing strictly upward at all times. The fact that this may not be the case with the outer cameras leads to the perspective corrected images being used in the processing.

This is accomplished by modelling a shift in the camera pose and determining the normal view from the captured view. In order to accomplish this, the effective focal distance of the camera is required. This value is needed in order to perform for the projective transformation from 3D coordinates into image pixel coordinates, and is gained during the intrinsic camera parameter estimation. FIG. 3 shows a diagram of this pose shift.

When correcting for perspective, the new camera position is at the same height as the original viewpoint, not the slant range distance. Thus all of the images from each of the cameras are corrected to the same scale.

For each image comparison of images from the chosen camera, it is assumed that there is no rotation or zooming differences between the frames. This way only the translation in x and y pixels need be estimated. Having obtained the necessary parameters of the differences in position of the two images, they can be placed in their correct relative positions. The next frame is then analyzed in a similar manner and added to the evolving mosaic image. A description of the implementation procedures used in this invention for translation estimation in Fourier space will now be given.

In Fourier space, translation is a phase shift. The differences in the phase to determine the translational shift. Let the two images be described by f₁(x,y) and f₂(x,y) where (x,y) represents a pixel at this position should be utilized. Then for a translation (dx,dy) the two frames are related by
f₂(x,y)=f₁(x+dx,y+dy)

The Fourier transform magnitudes of these two images are the same since the translation only affects the phases. Let our original images be of size (cols,rows), then each of these axes represents a range of 2π radians. So a shift of dx pixels corresponds to 2π.dx/cols shift in phase for the column axis. Similarly, a shift of dy pixels corresponds to 2π.dy/rows shift in phase for the row axis.

To determine a translation, a Fourier transform of the original images, compute the magnitude (M) and phases (φ) of each of the pixels and subtract the phases of each pixel to get dφ. The average of the magnitudes (they should be the same) and the phase differences are taken and a new set of real ( [symbol] ) and imaginary (ℑ) values as [symbol] =M cos(dφ) and ℑ=M sin(dφ) is computed. These ( [symbol] , ℑ) values are then inverse Fourier transformed to produce an image. Ideally, this image will have a single bright pixel at a position (x,y), which represents the translation between the original two images, whereupon a subpixel translation estimation may be made.

An important point to consider is which camera to use in calculating the mosaicing parameters. When asking this question the primary consideration is that of overlap, and how to get the maximum effective overlap between frames. It is here that an added benefit is found to having the outer cameras angled. If the centre camera is used then the distance subtended by the view of a single frame along the central axis of that frame is
d_{c}=2h tan(τ′/2)

When the camera is rolled to an angle of θ₁ degrees to the vertical as shown in FIG. 2, then the distance subtended by the view of a single frame along the central axis is
d₁=2h tan(τ′/2)/cos(θ₁)

which is greater than d_{c} for all θ₁≠0. This property is illustrated in FIG. 4.

Care must be exercised here however as according to this argument one of the cameras at the greatest angle θ₂ should be used. Two reasons count against this choice. Firstly, the pixel resolution at the outer limits of the corrected image is the poorest of all the imaged areas. Secondly, and most importantly, due to the enforced redundancy in the coverage, and that most vehicles will fall short of the maximum width limits, the outer region of this image (that which should correspond to the maximum overlap) does not view the underside of the vehicle at all. In this case most of the image will contain stationary information. For these reasons it is recommended that one of the cameras angled at θ₁ degrees should be used.

Given the mosaicing parameters, the final stage of the process is to stitch the corrected images into a single view of the underside of the vehicle. The first point to stress here is that mosaicing parameters are only calculated along the length of the vehicle, not between each of the cameras. The reason for this is that there will be minimal, as well as variable, overlap between camera views. These problems mean that any mosaicing attempted between the cameras will be unreliable at best. For this reason each of the camera images at a given instant in time are cropped to an equal number of rows, and subsequently placed together in a manner which assumes no overlap.

These image strips are then stitched together along the length of the car using the calculated mosaicing parameters, providing a complete view of the underside of the vehicle in a single image. This stitching is performed in such a way that the edges between strips are blended together. In this blending the higher resolution central portions of each frame are given a greater weighting.

A final point to note here is that when the final stitched result is calculated, each of the pixel values is interpolated directly from the captured images. This is achieved through use of pixel maps relating the pixel positions in the corrected image strips directly to the corresponding sub-pixel positions in the captured images. The advantage of adopting this approach is that only a single interpolation stage is used. This has the effect of not only reducing memory requirements and saving greatly on processing time, but also the resultant image is of a higher quality than if multiple interpolation stages had been used; a schematic for this process is provided in FIG. 5. The process of generating the pixel maps correcting for camera calibration and perspective correction are combined mathematically in the following way.

If u is the corrected pixel position, the corresponding position in the reference frame of the camera, normalized according the camera focal length in y pixels (β) and centred on the principle point (u₀,v₀), is c′=[(c₁″,c₂″,c₃″)/c₄″−(u₀,v₀)]/β where c″=PR_{y}RₓP⁻¹u. The pitch and roll are represented by the rotation matrices Rₓ and R_{y} respectively, with P being the perspective projection matrix which maps real world coordinates onto image coordinates. Following this the pixel position in the captured image is calculated as c=Aτ_{c′}c′. The scalar τ_{c′} represents the radial distortion applied at the camera reference frame coordinate c′. The matrix A is as defined previously.

The apparatus and method of the present invention may also be used to re-create each of the images from which the mosaiced image was created.

Once the mosaiced image has been created, it can be displayed on a computer screen. If an area of the image is selected on the computer screen using the computer cursor, the method and apparatus of the present invention can determine the image from which this part of the mosaic was created and can select this image frame for display on the screen. This can be achieved by identifying and selecting the correct image for display or by reversing the mosaicing process to return to the original image.

In practice, this feature may be used where a particular part of an object is of interest. If for example, the viewer wishes to inspect a part of the exhaust on the underside of a vehicle then the image containing this part of the exhaust can be recreated.

Improvements and modifications may be incorporated herein without deviating from the scope of the invention.

1. Apparatus for inspecting the under side of a vehicle, the apparatus comprising:
a plurality of cameras located at predetermined positions and angles relative to one another, the cameras pointing in the general direction of the area of an object to be inspected; and
image processing means provided with
(i) a first module for calibrating the cameras and for altering the perspective of image frames from said cameras and
(ii) a second module for constructing an accurate mosaic from said altered image frames.

2. Apparatus as claimed in claim 1 wherein the cameras are stationary with respect to the vehicle.

3. Apparatus as claimed in claim 1 or claim 2 wherein the plurality of cameras are arranged in a linear array.

4. Apparatus as claimed in any preceding Claim wherein the cameras have overlapping fields of view.

5. Apparatus as claimed in any preceding Claim wherein the first module is provided with camera positioning means which calculate the predetermined position of each of said cameras as a function of the camera field of view, the angle of the camera to the vertical and the vertical distance between the camera and the position of the vehicle underside or object to be inspected.

6. Apparatus as claimed in claim 5 wherein camera perspective altering means are provided which apply an alteration to the image frame calculated using the angle information from each camera.

7. Apparatus as claimed in any preceding Claim wherein the images from each of said cameras are altered to the same scale.

8. Apparatus as claimed in claim 6 or claim 7 wherein the camera perspective altering means models a shift in the angle and position of each camera relative to the others and determines an altered view from the camera.

9. Apparatus as claimed in any preceding Claim wherein the first module includes camera calibration means adapted to correct spherical lens distortion and/or non-equal scaling of pixels and/or the skew of two image axes from the perpendicular.

10. Apparatus as claimed in any preceding Claim wherein the second module is provided with means for comparing images in sequence which allows the images to be overlapped.

11. Apparatus as claimed in claim 10 wherein a Fourier analysis of the images is conducted in order to obtain the translation of x and y pixels relating the images.

12. A method of inspecting an area of an object, the method comprising the steps of:
(a) positioning at least one camera, taking n image frames, proximate to the object;
(b) acquiring a first frame from the at least one camera;
(c) acquiring the next frame from said at least one camera;
(d) applying calibration and perspective alterations to said frames;
(e) calculating and storing mosaic parameters for said frames;
(f) repeating steps (c) to (e) n−1 times; and
(g) mosaicing together the n frames from said at least one camera into a single mosaiced image.

13. A method as claimed in claim 12 wherein the object is the underside of a vehicle.

14. A method as claimed in claim 12 or claim 13 wherein a plurality of cameras is provided, each located at predetermined positions and angles relative to one another, the cameras pointing in the general direction of the object.

15. A method as claimed in claim 14 wherein the predetermined position of each of said cameras is calculated as a function of the camera field of view and/or the angle of the camera to the vertical and/or the vertical distance between the camera and the position of the vehicle underside.

16. A method as claimed in any one of claims 12 to 15 wherein images from each of said cameras are altered to the same scale.

17. A method as claimed in any one of claims 14 to 16 wherein perspective alteration applies a correction to the image frame calculated using relative position and angle information from each camera.

18. A method as claimed in claim 17 wherein perspective alteration models a shift in the angle and position of each camera relative to the others and determines the view therefrom.

19. A method as claimed in any one of claims 12 to 18 wherein calibration of the at least one camera corrects spherical lens distortion and/or non-equal scaling of pixels and/or the skew of two image axes from the perpendicular.

20. A method as claimed in any one of claims 12 to 19 wherein mosaicing the images comprises comparing images in sequence, applying fourier analysis to the said images in order to obtain the translation in x and y pixels relating the images.

21. A method as claimed in claim 20 wherein the translation is determined by
(a) Fourier transforming the original images;
(b) Computing the magnitude and phase of each of the images;
(c) Subtracting the phases of each image;
(d) Averaging the magnitudes of the images; and
(e) Inverse Fourier transforming the result to produce a correlation image.

22. A method as claimed in any one of claims 12 to 21 wherein the positioning of the at least one camera proximate to the vehicle underside is less than the vehicle's road clearance.

23. A method of creating a reference map of an object, the method comprising the steps of obtaining a single mosaiced image, selecting an area of the single mosaiced image and recreating or selecting the frame from which said area of the mosaiced image was created.

24. A method as claimed in claim 23 wherein the area of the single mosaiced image is selected graphically by using a cursor on a computer screen.
